(19) United States
(12) Patent Application Publication
(10) Pub. No.: US 2024/0367510 A1
(43) Pub. Date: Nov. 7, 2024

(54) Single-axis agricultural machine with continuous speed variation and independent power take-off

(71) Applicant: BCS S.P.A., Milano (IT)

(72) Inventor: Fabrizio Omodeo Vanone, Mortara (PV) (IT)

(21) Appl. No.: 18/652,186

(22) Filed: May 1, 2024

(30) Foreign Application Priority Data
May 4, 2023 (IT) 102023000008787

(51) Int. Cl. B60K 17/28; B60K 17/356; B60K 25/06

(52) U.S. Cl. CPC B60K 17/28; B60K 17/356; B60K 25/06; B60Y 2200/22

(57) ABSTRACT

A single-axis agricultural machine with continuous speed variation and independent power take-off includes an internal combustion engine, a clutch assembly, wheels, a power take-off for work tools controlled by a gearbox, and a guide handlebar with controls. A primary shaft extends from the clutch assembly and controls a gear reduction, at the output of which a coupling transmits the motion to a shaft of the power take-off. A hydrostatic assembly draws motion from the internal combustion engine through the clutch assembly, a first kinematic chain being coupled thereto, and is connected to a second kinematic chain that retracts in the gearbox and that controls an axle of the wheels through a final reduction. Three shaft assemblies transmit motion respectively from the engine toward the power take-off, from the engine toward the hydrostatic pump, from the hydrostatic motor to the final reduction, and from the final reduction toward the wheel axle, the three shaft assemblies being arranged orthogonal to each other.

### FIELD OF THE INVENTION

The present invention refers to a single-axis agricultural machine with continuous speed variation and independent power take-off.

### BACKGROUND OF THE INVENTION

It is known to those skilled in the art that single-axis agricultural machines, driven by an operator standing on the ground, include motor cultivators or motor mowers. Such motor cultivators or motor mowers generally comprise a load-bearing frame on which an internal combustion engine of limited power (e.g. up to 15 kW-20 HP) is installed.

That engine, with interposition of a transmission assembly or gearbox provided with a clutch and coupled to the single axle, is used to drive both a pair of wheels for the movement of the agricultural machine and a power or power take-off, which is also called “PTO”.

In fact, both rear tools, such as, for example, “cutters” for hoeing the soil, and front tools such as, for example, mowing bars for cutting grass, are normally connected to the aforementioned power or power take-off.

An operator standing on the ground controls that type of agricultural machine and follows its movement by driving it by means of a handlebar (also called handles). This handlebar carries the controls for driving the agricultural machine (gas, brake, clutch, gearbox, drives of the work tools, etc.) arranged in an appropriate manner.

As mentioned, in particular, the agricultural machine can be configured as a motor cultivator. In this configuration, the agricultural machine has a rear tool, called cutter for hoeing the soil, that is connected to the power take-off (PTO). This tool is facing the user who has therefore in front, in succession: the cutter, the handles, the gearbox, the wheel axle and the engine.

In a second configuration, a single-axis agricultural machine of this type has the handles positioned on the engine side. The tool is facing forward and, therefore, the user has in front, in succession: the handles, the engine, the gearbox, the wheel axle and the tool. This machine configuration is suitable for the use of front tools, such as for example mowing bars, lawn mowers or mulchers and it is precisely in this configuration that the machine is called a “motor mower”.

Sometimes it is possible, on the same single-axis agricultural machine, to rotate the handles, and the machine can be used both with the cutter and with front tools and, in this case, that provides for a “reversible” single-axis agricultural machine.

As mentioned, most of these single-axis agricultural machines are provided with endothermic engines of limited power (about 15 KW-20 HP). The transmission of the motion from the engine to the wheels and the possibility of varying the movement speed or of reversing the direction of travel are incorporated in the gearbox provided in these machines.

In the most common single-axis agricultural machines, a mechanical transmission with a mechanical gearbox or in any case a mechanical belt gearbox is used.

The mechanical gear transmission allows obtaining the best cost-benefit ratio compared to belt transmission, being more reliable and long-lasting.

Those single-axis agricultural machines have affordable costs and are accessible to various users.

There are also machines of significantly higher costs that have a hydrostatic transmission.

The use of a hydrostatic transmission for agricultural machines with limited power essentially presents two types of problems: costs and dissipation of power in heat.

Moreover, in the machines with hydrostatic transmission it is possible to vary the advancement speed continuously, leaving the number of revolutions of the endothermic engine unchanged. This provides for a virtually infinite range of speeds.

When there is a hydrostatic transmission to drive both the tool and the movement of the agricultural machine, it is necessary to use expensive and delicate components of the related system, such as valves, distributors, solenoid valves, connections that are in some ways even delicate, etc.

This part of the machine causes costs to rise disproportionately, which leads it to be, as a whole, inaccessible to a large customer base.

The dissipation of power in heat is another relevant aspect that can cause problems when both the tools and the traction of the wheels are in operation.

In fact, only a minimum fraction of the power is used to move the machine, while the greatest use of power is for driving the work tools.

It must therefore be taken into account that when a hydrostatic transmission is used, the containment of the heating deriving from the hydrostatic component involves in the known machines the use of special and costly expedients, such as for example large diameter fans, circuits and heat exchangers, which are expensive and which in any case constitute additional members.

The arrangements hitherto known in single-axis agricultural machines provide for a structure with a significant number of mechanical components of the transmission with relative encumbrances and problems of general type.

Document CH688857 A concerns a self-propelled and steering operating machine, with a hydrostatically driven drive axle and a front connection device for attaching work equipment.

In this machine the hydrostatic pump is housed in the gearbox housing/differential while the hydrostatic motor is separated, placed externally and joined with a high-pressure hose.

The hydrostatic pump has an axis parallel to that of the thermal engine and the arrangement of various axles is not described.

Document EP2548788 refers to a previous single-axis agricultural machine comprising an internal combustion engine, a clutch assembly and a gearbox, a pair of wheels and a power take-off for work tools, as well as a steering handlebar provided with controls by the same applicant.

### SUMMARY OF THE INVENTION

It is, therefore, a general object of the present invention to overcome the drawbacks of the above-described state of the art.

In particular, an object of the present invention is to provide a single-axis agricultural machine capable of moving within a virtually infinite range of speeds that are seamlessly selectable within functional limits. At the same time, such a machine must be able to guarantee optimal operation and efficiency of the mounted and operating work tools, driven by a mechanical power take-off whose speed is independent of that of the advancement of the machine.

Another object of the present invention is to contain the heating deriving from the hydrostatic component without using the previously mentioned particular and expensive precautions, such as bulky fans, circuits, heat exchangers, etc.

Another object of the present general invention is to realize, at low cost, a single-axis agricultural machine with continuous speed variation and independent power take-off with high reliability.

The above objects are achieved by a single-axis agricultural machine with continuous speed variation and independent power take-off made according to independent claim 1 and the dependent claims that follow.

A single-axis agricultural machine according to the invention provides for heat dissipation to be achieved also due to the particular shape of the housing, which also operates as an oil tank.

In a single-axis agricultural machine with continuous speed variation and independent power take-off with high reliability according to the invention, an arrangement and structure are realized that minimize the number of mechanical components of the transmission by adopting an innovative scheme.

This innovative scheme is achieved by having the main PTO shafts, wheel axle and hydrostatic assembly with reducer arranged according to the three orthogonal axes of a three-dimensional Cartesian system.

### BRIEF DESCRIPTION OF THE DRAWINGS

The structural and functional characteristics of the present invention and its advantages over the known art will be even clearer and more evident from an examination of the following description, with reference to the attached schematic drawings, which show an example of implementation of the invention. In the drawings:

FIGS. 1a and 1b represent, in schematic side and top plan views, an agricultural machine according to the present invention in a schematic motor cultivator configuration;

FIGS. 2a and 2b represent, in respective side and top plan views, an agricultural machine according to the present invention in a schematic motor mower configuration;

FIG. 3 is a perspective view of the gearbox assembly of an agricultural machine according to the invention;

FIG. 4 is a perspective view of a detail of the gearbox assembly of FIG. 3 in the part facing the tool, i.e., in a view rotated 180° with respect to that of FIG. 3;

FIG. 5 is an additional perspective view illustrating, on an enlarged and partially split scale, a mounted detail of the particular cooling fan shown exploded in FIG. 3;

FIG. 6 is a vertical section in longitudinal elevation of the gearbox assembly of a machine according to the invention, in the perspective position already shown in FIG. 3;

FIG. 7 is a perspective view of the internal shafts as mounted in the transmission. In this figure, the three orthogonal directions that characterize the arrangement are highlighted, and the gearbox housing and accessories have been removed for greater clarity;

FIGS. 8 and 9 show two partially sectioned and split perspective views of the gearbox housing of a machine according to the present invention.

FIG. 10 shows a partially sectioned perspective view of the hydrostatic assembly at the pump and the pin that controls it, with the control connected to the handles;

FIGS. 11a and 11b are vertical sections in longitudinal elevation of the gearbox assembly of a machine according to the invention at the mechanism for the idling maneuvering, the gearbox housing and some accessories having been removed for greater clarity.

For the illustrations provided in the drawings, use is made in the following description of identical numerals to indicate construction elements having the same function. Further, for illustration clarity, some numerical references may not be repeated in all the figures.

### DETAILED DESCRIPTION OF EMBODIMENTS OF THE INVENTION

Indications such as “vertical” and “horizontal”, “upper” and “lower” (in the absence of other indications) are to be read with reference to the assembly (or operating) conditions and with reference to the normal terminology used in current language, where “vertical” indicates a substantially parallel direction to that of the gravitational force vector “g” and horizontal to a direction perpendicular thereto.

With reference to the figures, which are to be considered exemplary and non-limiting, an embodiment of a single-axis agricultural machine with continuous speed variation and independent power take-off is shown therein.

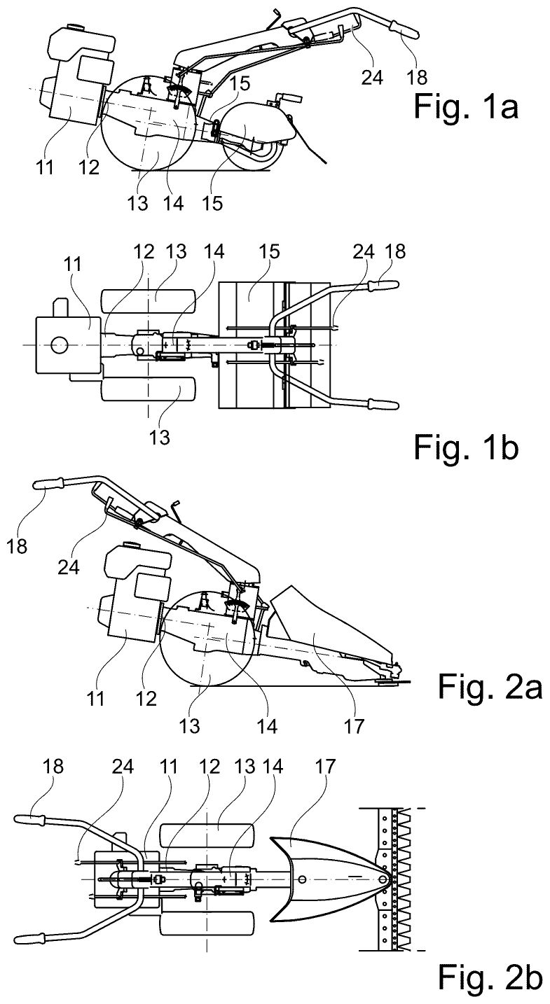

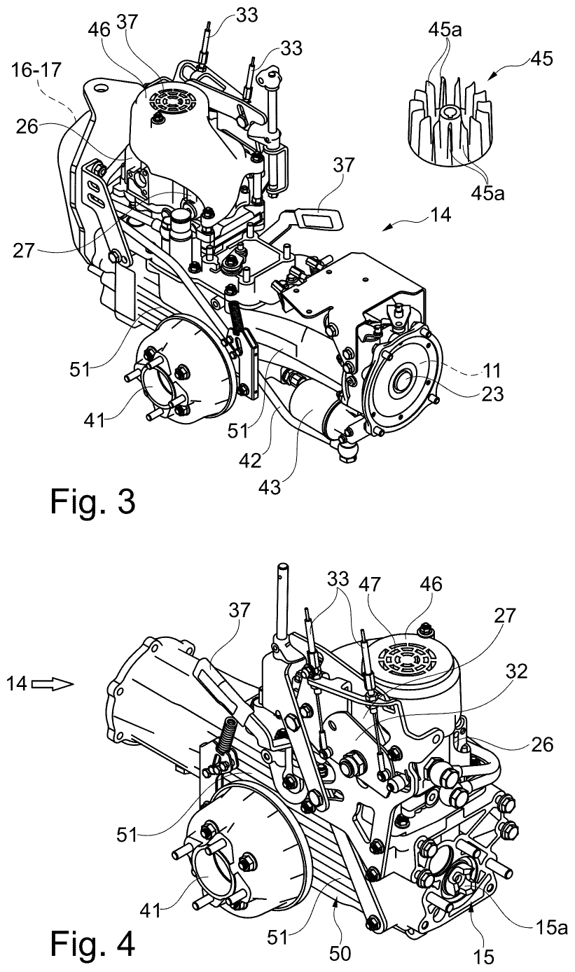

With specific reference to FIGS. 1a, 1b and 2a, 2b, two single-axis agricultural machines with continuous speed variation and independent power take-off according to the invention are shown in schematic views, the first in a motor cultivator configuration and the second in a motor mower configuration.

In both cases, this single-axis agricultural machine is suitable for use by an operator standing on the ground.

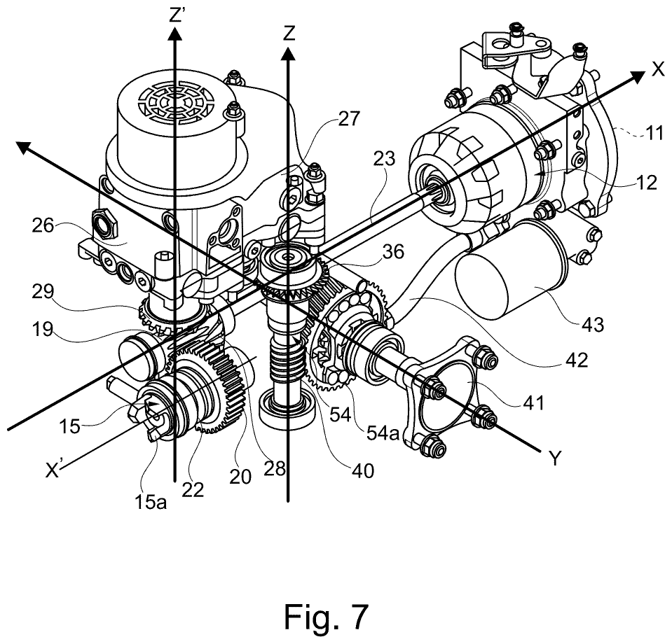

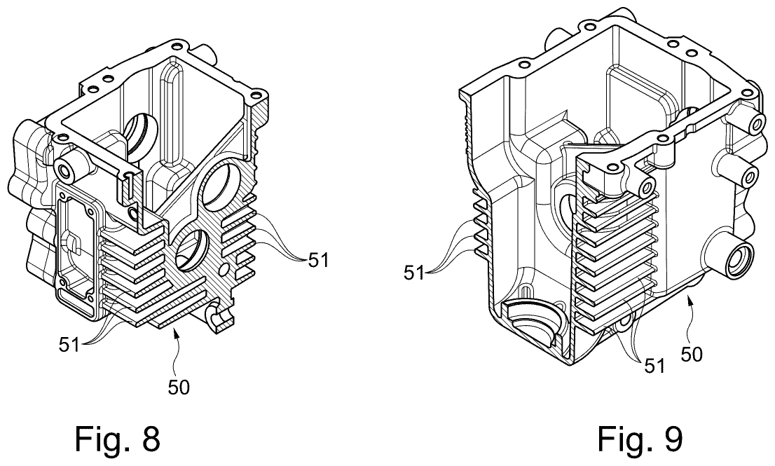

The machine comprises a series of main parts in sequence. Firstly, there is provided an internal combustion engine 11, with limited power (approximately up to 15 kW-20 HP) (shown only in its attachment flange and indicated with a dotted line in FIGS. 6, 7), a clutch assembly 12 and a gearbox 14. Two wheels 13 and a power take-off 15 for a generic work tool, such as for example a cutter 16 or a mowing bar 17, in addition to a motorcycle-type guiding handlebar 18, called “handles”, equipped with controls 24 follow. The two wheels 13 and the power take-off 15 are controlled by the gearbox 14. In particular, a primary shaft 23 of the internal combustion engine 11 and a shaft of the power take-off 22 are arranged according to two axes X and X′ arranged parallel to each other. An axis 41 of the wheels 13, arranged according to the direction Y, is perpendicular to the axes X of the internal combustion engine 11 and X′ of the shaft of the power take-off 22.

The clutch assembly, for example, consists of a multiple disc clutch in an oil bath, as best shown by the circle 12a in FIG. 6. A typical example of this assembly is described in patent EP2100491B1 to the same Applicant.

This clutch assembly 12 cooperates in cascade with a primary shaft 23, a reduction gear 19 and 20 and a coupling 21 to transmit motion to a shaft 22 of the power take-off 15, to which any tool (for example the cutter 16 or the mowing bar 17 or other tool) may be attached.

The particular shape of a three-toothed coupling 15a of the power take-off 15 (better visible in FIG. 4) makes the coupling easy during tool replacement operations and ensures a reliable power transmission. A typical example of this assembly is described in patent EP2374649B1 to the same Applicant.

The transmission of the power to the tool, being completely mechanical with gears and supports in an oil bath, ensures a very high performance with minimal power losses. This is because the shafts that provide power to the above-mentioned tools are completely separated from the hydrostatic mechanism and their rotation speed is independent of the speed of the translation motion of the machine.

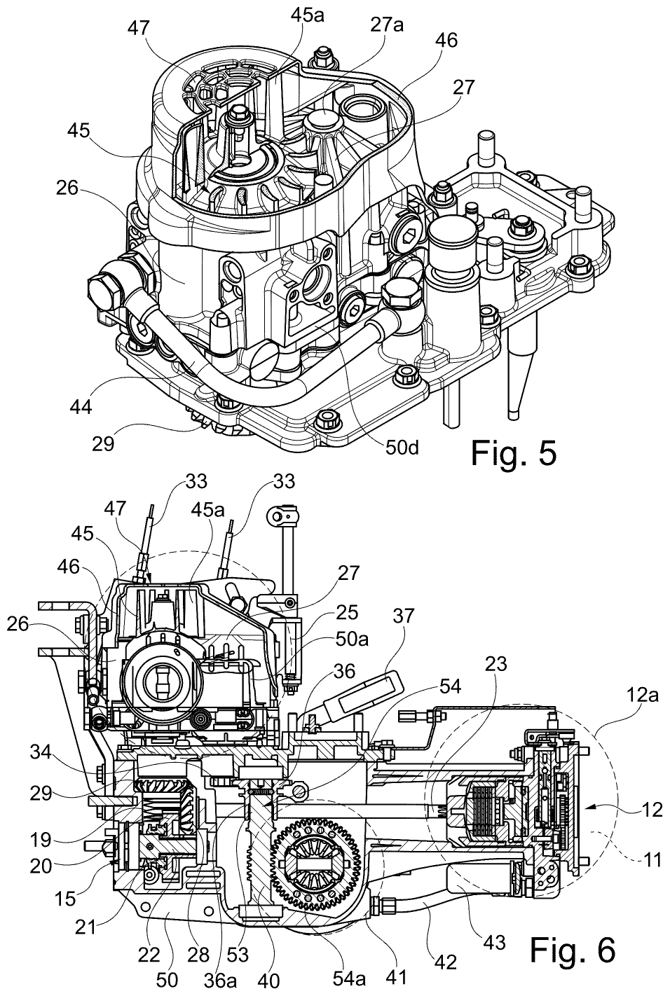

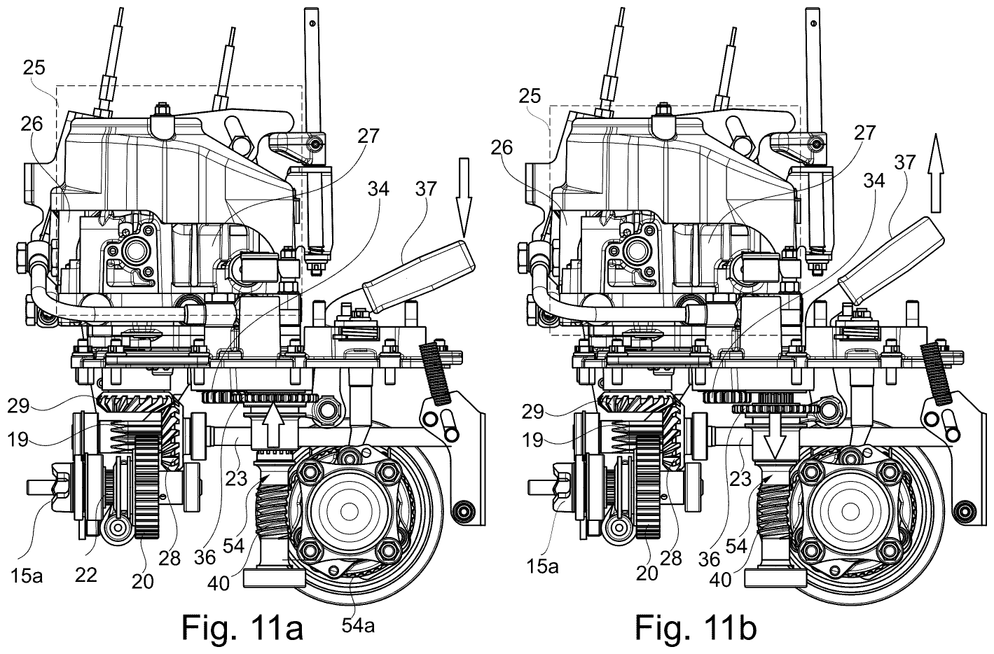

According to the present invention, the agricultural machine comprises in the gearbox 14 a hydrostatic assembly, identified overall with circle 25 of FIGS. 6, 11a and 11b, for the control and transmission of the motion to the wheels 13. A so-called “compact” system is used for this assembly. It essentially comprises a hydrostatic pump 26 and a hydrostatic motor 27, at least one of which has a variable displacement, which are arranged in a single compact unit enclosed within a single housing consisting of a housing 50a in FIGS. 5 and 6 obtained by melting. The hydrostatic assembly is connected to the primary shaft 23, from which the hydrostatic pump 26 is driven using only a pair of concurrent bevel gears 28, 29 having preferably, but not exclusively, a helical toothing. In fact, common straight gears, which are quite noisy, can also be used. A first kinematic chain is thus created that connects the hydrostatic assembly 25 to the primary shaft 23 so that the axis of the hydrostatic pump 26 arranged according to the direction Z is perpendicular to the axis X of the primary shaft 23.

In fact, the primary shaft 23 carries a keyed first bevel gear 28, which in turn controls a second bevel gear 29, which drives the hydrostatic pump 26 with a suitable ratio in order to obtain the right rotation rate, i.e. with a minimum reduction ratio.

A control unit 32 is connected to a remote control system for driving the hydrostatic motor 27, highlighted in the present example, by means of Bowden cables 33, wherein other solutions can also be used such as tie rods, actuators, servo mechanisms, etc.

By driving the hydrostatic pump 26 by means of the endothermic engine 11 and by varying the displacement by means of, for example, the control unit 32 with Bowden cables 33, the variation in speed and direction of the machine is obtained.

The rotation of the hydrostatic motor 27, or rather of its shaft indicated with 27a in FIG. 5, transmits the rotation motion to the gearbox through a second kinematic chain that will be described later.

The rotation of the hydrostatic motor 27, in fact, drags in rotation an additional gear 34 that is coaxial to the shaft of the hydrostatic motor 27.

This additional gear 34 causes the rotation of a gear 36, meshed to it, which brings the rotation motion within the gearbox 14. These gears 34, 36 provide the second kinematic chain.

In fact, it should be noted that the gear 36 is slidable, can be driven from the outside by means of a special lever 37 and allows the wheels 13 to be disconnected from the transmission if a thrust maneuver, with the endothermic engine off, were necessary. FIG. 11a shows the position of the lever 37 and of the gear 36 when the hydrostatic assembly is connected to the wheels, and FIG. 11b shows the same elements in the idle position.

The gear 36 engages, in fact, by means of toothings 53 obtained on a hollow extension 36a thereof, complementary toothings of a shaft 54, in turn provided with a gear section 40. The downward sliding of this gear allows the disengagement or uncoupling of the toothings 36 and 34 coupled to each other.

This gear section 40 operates as a transmission and controls an external control toothing 54a for an axis of the wheels 13, indicated as a whole with the circle 41 of FIG. 6. This axle 41 of the wheels 13 can be variously conformed, for example with a lockable central differential or steering assemblies with independent clutches and brakes or still reducers added before the wheels.

The hydrostatic assembly uses the same oil as the hydraulic fluid that lubricates the gearbox.

The oil is sucked by means of a pipe 42 through a filter 43 located at the farthest point from the casing assembly of the transmission.

The oil is then discharged from the hydrostatic assembly via a pipe 44 to the opposite end of the hydrostatic assembly. This arrangement results in a long path that the oil must travel between suction and discharge. This long path substantially favors the decrease in temperature.

The use of the hydrostatic assembly solely for the movement of the agricultural machine results in modest heat generation compared to the known agricultural machines that are completely hydrostatically controlled both for the operation of the tools and for movement.

Moreover, in a machine according to the present invention, this is mainly caused by the hydrostatic assembly even in the presence of minimal amounts of power dissipation by heat.

According to the invention, in order to further reduce this dissipation, it was thought to add to the arrangement a particular cooling assembly associated with the hydrostatic assembly.

In fact, the use of a fan 45 is provided, which is enclosed by a bell casing 46, arranged above the fan 45 such that it directs the air flow to lap the entire hydrostatic assembly, creating a system with very small dimensions.

The fan 45 has a general encumbrance in the shape of a cylinder, in which the side surface is formed by radial fins 45a fixed to a circular base. The fins 45a are arranged like a palisade, extend upwards from the base, and are joined only to the lower base which is keyed on a drive shaft.

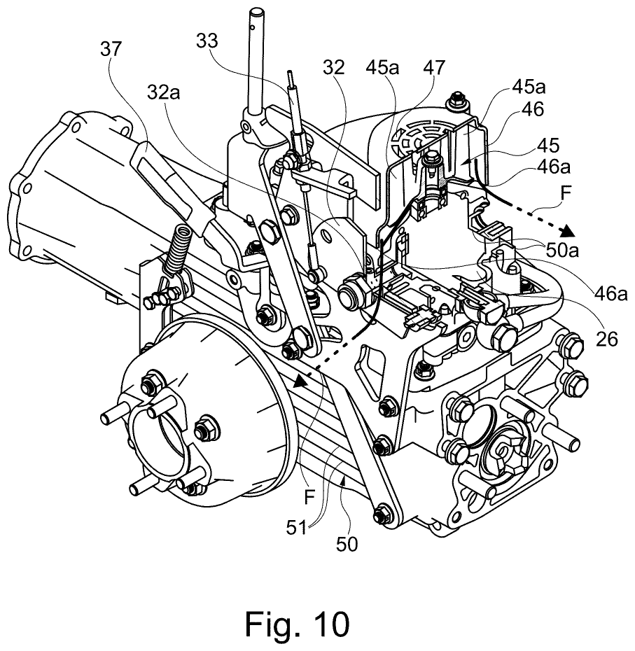

The fins 45a, arranged like a palisade, are fixed to the circular base with free terminal ends, so that the air can enter inside the fan easily and widely (see FIG. 10).

This way, in the upper part, the fan remains completely open to allow the suction of air that will be centrifuged outside. The casing 46 is shaped to follow as a fairing the external shape of the fan 45 so as to guide the cooling air flow downwards as shown in FIG. 10 according to the arrows indicated with F.

Fresh air is sucked from central holes 47 in the upper surface of the casing, through which air enters which, centrifuged radially, is directed to travel inside the casing 46 according to its outline and is discharged outside through a peripheral opening indicated with 46a in FIG. 10. A system is thus obtained, in which air at ambient temperature is forced to pass quickly between the wall of the hydrostatic assembly and the casing 46 increasing heat removal capacity. In the known solutions, this function is entrusted to larger-sized fans generating a free air flow with a less effective cooling effect. Another expedient to contain the heating of the oil is made possible by the particular shape of the housing 50, which has a series of deep finnings 51 on both sides. The finnings 51 contribute to the structural strength of the transmission housing, but above all increase the surface in contact with the cooler ambient air, thus favoring heat disposal.

This makes it possible, unlike the known machines, to drastically reduce the dissipation of power due to heat because it limits the temperature of the oil while maintaining its viscosity within the optimal limits for the correct performance of the hydrostatic assembly.

A solution such as the one presented here proposes a single-axis agricultural machine with continuous speed variation and independent power take-off that optimizes operation by reducing costs.

Even in the presence of a hydrostatic assembly in this agricultural machine, there is almost a total absence of expensive components of the hydraulic system causing the actuation of the power take-off made using a traditional mechanical transmission.

By maintaining control of the power take-off made using a mechanical transmission and an endothermic engine, the advantages deriving from the known reliability of these components have been preserved.

The hydrostatic component couples on this base, the use of which is thus less invasive both from a technical and economic point of view.

In contrast to the solutions known in this power range, in which cooling is generally entrusted to a simple free axial flow fan, the provision of a centrifugal fan with tangential fins 45a and faired casing with large and numerous finnings improves cooling with a forced air flow.

Advantageously, moreover, the shape of the transmission housing rich in fins 45a increases its heat exchange with the atmospheric air.

By limiting the use of the hydrostatic technology to traction alone, the power losses typical of the hydrostatic assemblies are thus minimized, while providing non-negligible advantages.

An additional innovative feature with respect to the prior art is now described.

According to the invention, an arrangement is made of the shafts inside the gearbox assembly and transmission, parallel to the three orthogonal axes of a Cartesian space. This arrangement allows the following advantages to be achieved:

the mechanical control shafts of the power take-off (for example, the primary shaft 23) are arranged according to a direction axis X in FIG. 7. A long shaft allows overcoming the distance between the endothermic engine and the tool, transmitting power reliably, economically and with high efficiency. By means of a pair of gears and a compact shaft 22, which are equally arranged according to the direction axis X, the correct rotation rate for the PTO is obtained;

the wheel axle 41, arranged according to a direction Y in FIG. 7, enables the machine to move forward and backward as well as makes it possible for various accessory components such as for example differential and brakes to be housed;

the shafts (for example the shaft 54 connected in output from the hydrostatic motor 27 and the shaft integral with the bevel gear 29) that move the hydrostatic assembly and that are driven by it are arranged according to axes of directions Z and Z′ that are parallel to each other in FIG. 7.

The hydrostatic assembly is thus optimally positioned near the center of gravity of the machine, away from heat sources and exposed to air, in a raised position for easy maintenance or replacement and with a favorable path of the control cables. The forced air cooling fan is located above it, from where it sucks cooler and cleaner air from the contaminants typical in agricultural use such as plant residues and contaminants deriving from the soil.

Advantageously, therefore, it is worth reiterating that both the cooling system and the arrangement of the shafts are made possible by the adoption of a compact hydrostatic assembly enclosed within a single monolithic casing 50a. In this way, according to the present invention, a single-axis agricultural machine with continuous speed variation and independent power take-off with high reliability has been created, which has an arrangement and structure that minimizes the number of the mechanical components of the transmission by adopting an innovative scheme.

This innovative scheme is achieved by having, as previously mentioned, the main PTO shafts, the wheel axle and the hydrostatic assembly with reducer arranged according to the three orthogonal axes of a three-dimensional Cartesian system.

The purpose mentioned in the preamble of the description is thus achieved.

The scope of protection of the present invention is defined by the appended claims.

The invention claimed is:

1. A single-axis agricultural machine with continuous speed variation and independent power take-off, comprising:
an internal combustion engine of limited power;
a clutch assembly;
a gearbox;
wheels;
a power take-off for work tools;
a guide handlebar provided with controls, the wheels and the power take-off being controlled by the gearbox, wherein a primary shaft extends from the clutch assembly for controlling a gear reduction, a coupling being provided at an output of the gear reduction there to transmit motion to a shaft of the power take-off; and
a hydrostatic assembly that comprises a hydrostatic pump and a hydrostatic motor and that draws motion directly from the internal combustion engine through the clutch assembly and a first kinematic chain, wherein the hydrostatic assembly is connected to a second kinematic chain that retracts in the gearbox, the second kinematic chain, through its final transmission gear, controlling an axle of the wheels;
three assemblies of shafts for transmitting motion respectively:
from the internal combustion engine toward the power take-off,
from the internal combustion engine toward the hydrostatic pump, and
from the hydrostatic motor toward the final transmission gear, and
from the final transmission gear toward the axle of the wheels and to the wheels,
wherein the three assemblies of shafts are arranged on axes orthogonal to each other,
wherein the primary shaft of the internal combustion engine and the shaft of the power take-off are arranged according to two axes parallel to each other, the axis of the wheels being arranged according to a direction that is perpendicular to the two axes of the internal combustion engine and of the shaft of the power take-off,
wherein an axis of the hydrostatic pump is arranged according to a direction perpendicular to the axis of the primary shaft, and
wherein a shaft in output from the hydrostatic motor arranged according to a direction perpendicular to a plane defined by the axis of the primary shaft and the axis of the wheels.

2. The single-axis agricultural machine according to claim 1, wherein in the hydrostatic assembly comprising the hydrostatic pump and the hydrostatic motor, at least one of the hydrostatic pump or the hydrostatic motor has a variable displacement, and wherein the hydrostatic pump and the hydrostatic motor are arranged in a single compact unit, the hydrostatic assembly being connected to the primary shaft of the gearbox.

3. The single-axis agricultural machine according to claim 1, wherein the hydrostatic pump and the hydrostatic motor of the hydrostatic assembly are arranged in a monolithic casing.

4. The single-axis agricultural machine according to claim 1, wherein the hydrostatic assembly is connected to the primary shaft of the gearbox by the first kinematic chain, which comprises a first bevel gear keyed on the primary shaft, the first bevel gear controlling a second bevel gear, which drives the hydrostatic pump.

5. The single-axis agricultural machine according to claim 4, wherein the second kinematic chain comprises a third gear coaxial to the shaft of the hydrostatic motor, the hydrostatic motor causing a rotation of a fourth gear, which returns a rotation motion within the gearbox.

6. The single-axis agricultural machine according to claim 5, further comprising a housing of the gearbox or transmission provided with finnings to favor thermal dispersion.

7. The single-axis agricultural machine according to claim 1, further comprising a cooling assembly associated with the hydrostatic assembly.

8. The single-axis agricultural machine according to claim 7, wherein the cooling assembly comprises a fan enclosed by a bell casing arranged above the fan such that the fan directs an air flow to lap an entirety of the hydrostatic assembly.

9. The single-axis agricultural machine according to claim 8, wherein the fan is shaped as a cylinder having a lateral surface defined by radial fins fixed to a circular base, and wherein the fins are arranged as a palisade and extend upwards from the circular base and are connected only to a lower base, which is keyed on a drive shaft.

10. The single-axis agricultural machine according to claim 8, wherein the bell casing has central holes in an upper surface thereof, air entering through the central holes and being centrifuged radially, being so directed to travel internally along the bell casing in an outline thereof and being discharged outside through a peripheral opening.
